(19) United States
(12) Patent Application Publication
(10) Pub. No.: US 2008/0255929 A1
(43) Pub. Date: Oct. 16, 2008

(54) Method for Obtaining Customer Feedback Through Text Messaging

(76) Inventor: Robert W. Mouton, New Orleans, LA (US)

Correspondence Address: HORNKOHL INTELLECTUAL PROPERTY LAW, P.L.L.C, P.O. BOX 210584, NASHVILLE, TN, 37221, US

(21) Appl. No.: 12/101,973

(22) Filed: Apr. 12, 2008

Related U.S. Application Data
(60) Provisional application No. 60/923,482, filed on Apr. 13, 2007.

(51) Int. Cl. G06Q 30/00; H04Q 7/20

(52) U.S. Cl. 705/10; 455/414.2; 455/466; 705/14

(57) ABSTRACT

A methodology and system for obtaining customer feedback via text messages from cellular phones uses an advertising display to solicit text message based feedback relating to a particular product or service. A receipt is generated at a point of sale when a transaction is consummated that identifies the time, place and goods or services associated with the transaction. The advertisement is positioned near the point of sale and prompts the customers to rate their service or experience and enter their identification code through text messages. A central server receives the text message responses and solicits additional feedback from the customers. Web based access to selected summary response data is provided to the customers. In addition, the retailer or advertiser can view more complete and unedited versions of the response data associated with their advertisements through a password protected web interface. GPS or cellular location technology is used when available to correlate the response data to a particular location or store. Directed advertisements are provided to the advertisers and customers based upon the products and services which they are associated with.

### CROSS REFERENCES TO RELATED APPLICATIONS

The present application is based upon and claims priority from co-pending Provisional Patent Application Ser. No. 60/923,482 filed Apr. 13, 2007.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

Text messaging, or texting, is the common term for the sending of short (160 characters or fewer) text messages from mobile phones using the Short Message Service (SMS). It is available on most digital mobile phones and some personal digital assistants with on-board wireless telecommunications. SMS gateways connect mobile SMS services with instant message (IM) services, the worldwide web, desktop computers, and even landline telephones. Devices which can connect to mobile phones and PDAs through protocols such as Bluetooth can also sometimes use that link to send SMS messages over the wireless network. The most common application of the service is person-to-person messaging, but text messages are also often used to interact with automated systems, such as ordering products and services for mobile phones, or participating in contests. Short codes, also known as short numbers are special telephone numbers, significantly shorter than full telephone numbers, which can also be used to address SMS and MMS messages from mobile phones or fixed phones.

Consumer surveys are often, conducted to determine consumers' opinions of various products and services. Unfortunately, it is difficult and expensive to find and question consumers willing to answer directed questions relevant to their purchases. In addition, the cost of hiring people to conduct surveys is high and the number of consumers involved necessarily small. While these surveys provide feedback, they don't provide every consumer an opportunity to respond and provide very little opportunity for the company performing the survey to advertise its products and services to its consumers and the survey participants.

### BRIEF SUMMARY OF THE INVENTION

An embodiment of the present invention is directed toward a method for obtaining customer feedback through text messaging. In accordance with the method, a customer is provided with a receipt having a transaction identification number and solicited with advertising media to provide opinion data regarding a provided product or service by sending a text message. The location, date and time of the customer's visit is determined through the customer texting the identification number, or through GPS or cellular telephone location technology if possible, and the location of the customer is correlated with the text message response. The text message is received and an automated response generated that includes requests for additional experiential data from the customer. Rewards are selectively provided to the customers based upon their sending the text message based feedback and the details of their transaction identified through the identification number. The rewards can take the form of coupons that can be downloaded from the web or electronic discounts on products and services related to the advertisement and transaction. The opinion and customer data is stored in a database and a summary of the opinion and customer data is compiled. Statistical data is also calculated based upon the text message responses. Public web access is provided to a first portion of the opinion and customer data and password restricted web access is provided to a second portion of the opinion and customer data. The password protected portion of the data is preferably restricted to an advertiser associated with the advertising media and includes summaries of data received from a plurality of customers that responded to the advertising media through text messages. In addition to the summary data, the advertiser can view response data correlated to particular locations, times, transactions and employees through the identification numbers. Directed advertisements are provided to the advertiser through the web that are selected to be relevant to a business of the advertiser.

Another embodiment of the present invention is directed toward a system for advertising and receiving customer feedback. The system includes a receipt generator that generates a receipt for a transaction that includes an identification number that can be used to identify the transaction. An advertising display is positioned at a point of sale to be viewed by a customer of a business and provide the customer an advertising message, a text number and a request for feedback related to the business from the customer. A central server receives text message responses and identification numbers from customers viewing the advertising display, prompts the customers to provide feedback related to the business and stores the data received from the customers. The central server includes software that determines if the customer is entitled to a reward based upon the responses and identification numbers received from the customer and, if the customer is entitled to a reward, provides the customer with instructions for obtaining the reward. The reward may be a coupon downloaded from the internet or a code for receiving a discount electronically. A web interface allows customers to access summary data related to feedback received from other customers. Access to portions of the web interface is restricted through passwords to advertisers that sponsor the relevant advertising displays. The central server includes software that selects advertisements for display to the customers and advertisers through the web interface based upon the content of the advertising display which they are associated with and the purchases they made. A statistical generator generates statistics based upon the customer data for review by an advertiser associated with the advertising display.

### BRIEF DESCRIPTION OF THE SEVERAL VIEWS OF THE DRAWINGS

FIG. 1 is a block diagram of a system for implementing an embodiment of the present invention;

FIG. 2 is a flow chart of a method of implementing an embodiment of the present invention; and

FIG. 3 is an illustration of an advertising display in accordance with an embodiment of the present invention.

### DETAILED DESCRIPTION OF THE INVENTION

The present invention is directed toward a methodology and system for obtaining customer feedback via text messages from cellular phones. The system provides for the use of a variety of advertising media, including displays at points of sale, billboards, television, radio and the internet to solicit customer feedback from consumers and businesses to determine their opinions of the food, goods and/or services acquired from a target provider and also provides any cellular phone user with the opportunity to win valuable monetary or non-monetary prizes as an inducement to provide such feedback.

Each customer preferably receives a distinct identification number on his or her receipt at the time a purchase is made. The customer is later prompted to text the identification number to a central sever to provide the advertising client with an easy means to exactly pinpoint the date and time of the customer's transaction and correlate the same with employees and or managers serving the customer. The identification number is generated by software in the point of sale terminals of the business. Upon making a purchase and seeing the advertisement, a cellular phone user can elect to forward a text message providing a store code or short description of their location, together with the user's opinion on the quality of the food, goods and services acquired from the target location and their identification number from their receipt that identifies the details of their transaction. This information is preferably entered in response to a series of inquiries received from the central server in response to the customer responding to the advertisement. The location of the user may also be obtained through 911 or GPS location functions of cellular networks if the information is available without the need to have the customer enter their identification number. The opinion transmitted by the cellular user responds to the grading criteria or question contained in the advertisements, and can be alphanumeric, relate to an advertised grading scale and/or include a brief statement in response to the aforesaid advertisement. The computer network receiving the text message generates a response confirming receipt of the user's text message and also provides the user with the opportunity to provide further feedback or comments, and/or respond to additional questions regarding their level of satisfaction with the goods or services provided by the target location. Multiple text message communications between the computer network and each user are anticipated, and the process is iterative. Such additional questions and/or feedback are provided by the user via additional text messages, telephone, email or access to an internet web page or blog, and any users providing such additional feedback preferably receive additional opportunities to win, monetary and/or non-monetary prizes. Furthermore, through the web interface, the customer can choose to participate in text based ordering and sales of products and services connected with the advertisement.

A database, internet web page, or blog is created that includes a summary of ratings and opinions received from users with respect to specific businesses. A portion of the information is made accessible to the public or a large audience of consumers. A high level participant or client, such as the owner of a targeted business, is provided restricted access, through a password or code, to a more detailed summary of responses from users. The information which the public can access can be edited and restricted automatically to eliminate clearly erroneous or otherwise inappropriate or undesirable material. The computer server preferably compiles a report summarizing the responses and feedback received from participating cellular phone users, on either an hourly, daily, weekly, monthly or annual basis, and thereby provides the targeted food, goods or service provider with meaningful real time feedback and statistics regarding the satisfaction level of its customers with respect to the food, goods or services provided at specific times throughout each business day.

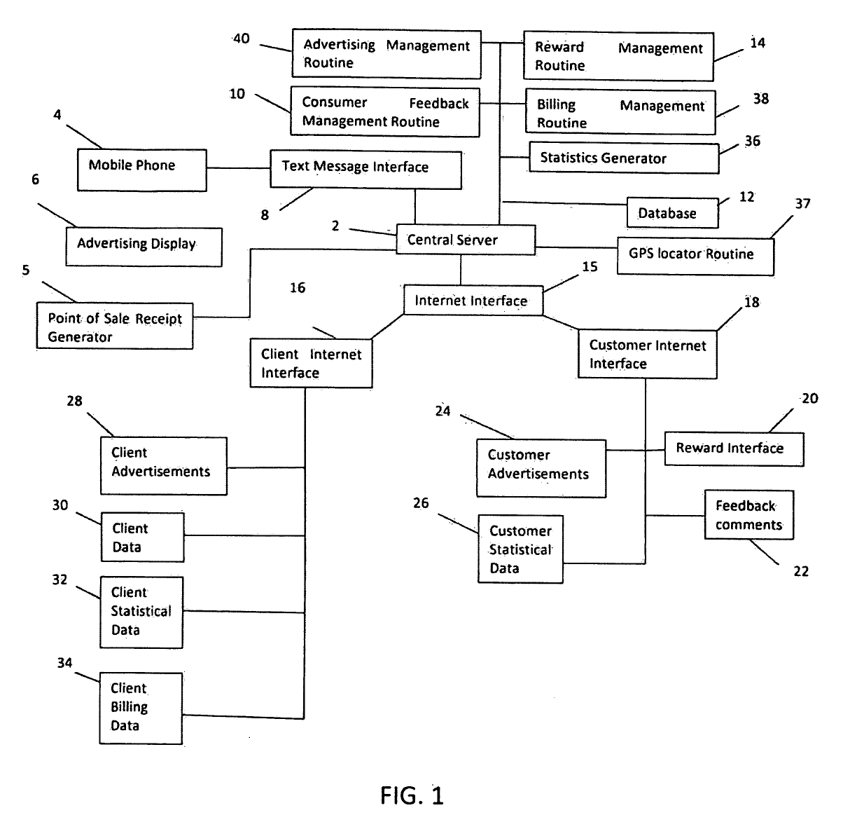

Referring now to FIG. 1, a block diagram of a system for implementing an embodiment of the present invention is shown. The system is managed by a central server 2. The central server 2 receives and responds to text messages from consumers having a mobile phone 4 through a text message interface 8. The consumers are prompted to send the text messages to the central server 2 by an advertising display 6 such as a sign or video screen. The advertising display 6 is preferably located near a point of sale terminal that includes a receipt generator 5 and solicits feedback related to products or services purchased by a customer at the point of sale. An identification number, such as a five digit alphanumeric code, is provided on a receipt produced by the receipt generator 5 at the time of purchase that can be used by the central server 2 to link the customer to a particular purchase, time, and location. The receipt generator 5 electronically provides the identification number and transaction data to the central server 2. The receipt generator 5 is preferably implemented, through the software in the business' cash register or point of sale terminal although a dedicated device can be used if desired. The identification number allows goods and services providers to use the response data to evaluate particular employees or store locations and even investigate particular transactions. The identification number provided by the receipt generator also provides a means to identify customers when providing rewards or coupons. A customer feedback server 10 processes the text message responses and identification numbers received from the customers and generates follow up questions to the responses. The follow up requests preferably include requests for identifying customer contact information such as an email address, text message number, phone number, address, etc. that can be used to contact willing customers for subsequent advertisements and surveys. The central server 2 records all relevant response data in a database 12 for analysis and review by an operator of the system.

The central server 2 uses either a random process or a reward management routine 14 to determine if the customer is entitled to any rewards based upon the customer's, text message responses, identification number and transaction details and informs the customer how to collect any rewards to which the customer is entitled. The reward may be a coupon that is downloaded from a web interface, or a discount applied to an account or purchase electronically through the use of a provided discount code and the customer's transaction identification code. The reward management routine 14 maintains a record of all rewards issued and redeemed that can be reviewed by the client associated with the advertising display 6 as discussed in more detail below.

Clients that are running advertising campaigns through the service provider can interface with the central server 2 through a client internet interface 16 such as a website. The client interface 16 allows the client to access client data 30 that includes the feedback and responses received from customers by the central server 2 as discussed herein. The advertising client can be provided access to all statistics and individual responses related to its advertisement while the data provided to the general public is limited to content reviewed by the advertiser to insure it is appropriate for publication. In addition, through the use of the identification code, the advertiser can determine if particular locations, products or employees are leading to favorable or unfavorable responses. The central server 2 uses a statistics generator 36 to compile summary statistics based upon the received responses and raw data that can viewed by the client as statistical data 32. The client interface 16 also allows the client to see their billing data 34 which may be based upon the number of responses received and the number of rewards awarded. The client's billing is managed by a billing management routine 38 run by the central server 2.

Directed client advertisements 28 are preferably displayed to the advertising clients while they use the client interface 16. For example, a restaurant based client is displayed advertisements for services directed toward restaurants such as cooking supplies and food products. The advertisements are selected and managed by the advertising management routine 40 of the central server 2.

Customers and consumers can access the web interface 15 of the system through a customer internet interface 18. Unlike the client internet interface 16, the customer internet interface 18 is preferably an unrestricted web page such that anyone on the web can access it. The customer internet interface 18 includes a reward interface 20 that allows a customer to receive or redeem an earned reward by printing out a coupons crediting an account or receiving a discount code. In addition, the customer can provide additional feedback or comments 22 related to a particular product, service or advertisement through the internet interface 18. Directed advertising 24 is displayed to customers using the customer interface 18. The directed advertising 24 is preferably selected for the customer based upon the type of advertisement that the customer is responding to or the products purchased by the customer as determined through their identification code. For example, a customer responding to an advertisement in a restaurant asking for text message feedback can be shown an advertisement for the restaurant, or a competitor of the restaurant, for which they are providing the feedback as identified by the text message or text number or the food that they purchased based upon their identification code.

The central server 2 uses a GPS locator routine 37 to examine any GPS or cellular location information received from the mobile phone 4 with the text message to determined the location of the sender if possible. This location information is then correlated with the response data from the customer so that the advertiser can determine if customers in certain areas are providing similar feedback without the need for the customers to enter their identification numbers. The ability to use this feature is dependent upon the ability of the phone and phone provider to provide the location information.

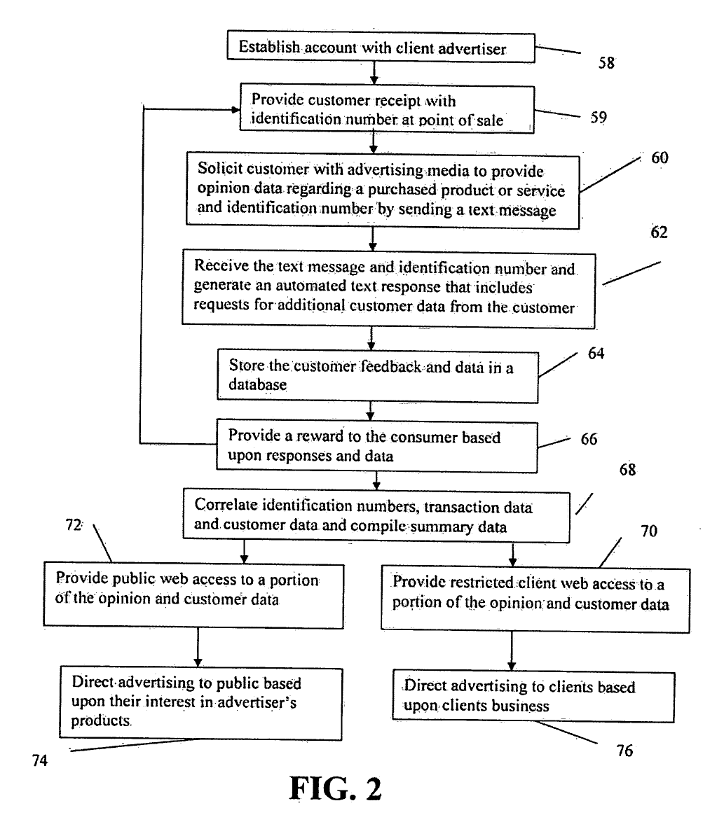

Referring now to FIG. 2, a flow chart of a method of implementing an embodiment of the present invention is shown. The method begins in block 58 with the establishing of account with an advertising client. When a customer of the client makes a purchase at a point of sale, a receipt with an identification number that identifies the time, location and nature of the transaction is provided to the customer in block 59. The customer is then solicited with advertising media to provide opinion data regarding the product or service provided by the client and their transaction identification number by sending a text message to a designated text number in block 60. In block 62, the text message responses and identification numbers are received and an automated text response generated that includes requests for additional customer data from the customer. These requests can include questions concerning the product or services, provider, employees, quality, etc. The customer feedback and data are stored in a database in block 64. In block 66, a reward is selectively provided to the customer based upon the customer's responses and/or data. For example, a 10% discount on a subsequent purchase can be rewarded for answering 5 questions related to the product or service by providing a discount code that can be redeemed at a given location. The method then proceeds back to block 59 wherein additional text messages and data are collected from additional customers that respond to the advertisement.

The identification numbers, transaction data and customer data are correlated and a summary compiled in block 68. The advertising clients are provided password limited access to the restricted access summary data, as shown in block 70, while the customers are provided access to specially selected portions of data related to the advertised product, as shown in block 72. This allows the publicly accessible data to be reviewed prior to publication while providing real time feedback to the advertiser. In addition, the advertiser can view correlated data that identifies opinion data for particular products, times or locations as discussed herein. While reviewing the restricted data, the advertisers are displayed advertisements that have been selected based upon the advertisers business as shown in block 76. In contrast, viewers of the publicly accessible portion of the data are shown advertisements based upon the products provided by the advertiser, block 74.

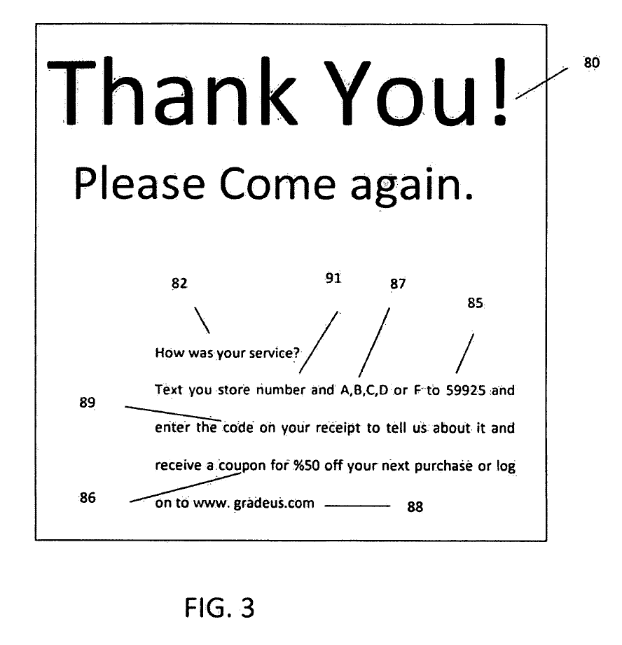

Referring now to FIG. 3, an illustration of an advertising display in accordance with an embodiment of the present invention is shown. The advertising display contains a general advertising message 80. In addition, a request to provide feedback 82 through the sending of text messages is displayed to the customer. A text number 85 is provided the advertisement for the customer to text feedback to. The text number 85 is preferably a short code so that the customer can easily remember the number and is more likely to respond. The advertisement preferably provides a request to enter a store number 91 that identifies the location of their purchase and a grading scale 87 that can be used to rate the services. The advertisement also indicates that the customer can receive a reward 86, such as coupon for 50% off, if the customer will respond to the indicated text number and enter their identification code 89 on their receipt. A web address 88 is also provided so that the customer can access data related to the advertisement over the web and provide additional feedback through the web interface.

Although there have been described particular embodiments of the present invention of a new and useful Method for Obtaining Customer Feedback Through Text Messaging, it is not intended that such, references be construed as limitations upon the scope of this invention except as set forth in the following claims.

What is claimed is:

1. A method for obtaining customer feedback through text messaging, said method comprising the steps of:
soliciting a customer with advertising media to provide opinion data regarding a provided product or service by sending a text message;
receiving said text message and generating an automated response that includes requests for additional customer data from said customer;
storing said opinion and customer data in a database;
compiling a summary of said opinion and customer data;
providing public web access to a portion of said opinion and customer data; and
providing password restricted web access to a portion of said opinion and customer data.

2. The method of claim 1 further comprising the step of determining a location of said customer through GPS or cellular telephone location technology.

3. The method of claim 1 further comprising the step of providing a reward to said customer for sending said text message.

4. The method of claim 1 further comprising the step of providing said customer with a unique identification number, via text message or a paper receipt at a point of sale, such that a product or service provider can determine a time and place of said customer's receipt of goods or services.

5. The method of claim 1 further comprising the step of gathering customer data and contact information and subsequently contacting said customer to participate in a subsequent advertising campaign or survey.

6. The method of claim 1 further comprising the step of compiling customer data including a time and location of delivery of purchased goods or services such that a goods or services provider can evaluate consumer perception of particular employees and business locations.

7. The method of claim 1 wherein said password protected portion of said data is restricted to an advertiser associated with said advertising media and includes summaries of data received from a plurality of customers that responded to said advertising media through text messages.

8. The method of claim 7 further comprising the step of providing directed advertisements to said advertiser through said web wherein the directed advertisements are selected to be relevant to a business of said advertiser.

9. A method of advertising, said method comprising:
providing a receipt with an identification code to a customer at a point of sale;
displaying a text message number on an advertisement along with a request for feedback near said point of sale;
receiving a plurality of text message responses to said advertisement;
processing said text message responses to compile summary data based upon said text message responses; and
providing public web access to a public portion of said data and password restricted web access to a private portion of said data.

10. The method of claim 9 wherein said restricted access portion of said data is accessible to an advertiser associated with said advertisement.

11. The method of claim 9 further comprising the step of selectively providing a reward to said customers based upon said text message responses or identification numbers.

12. The method of claim 9 further comprising prompting said customer to text said identification code to said text message number and using said identification code to correlate a time, location and purchase with said text message response.

13. The method of claim 9 further comprising the step of directing web advertising to customers based upon the advertisements to which the customers are providing feedback.

14. A system for advertising and receiving customer feedback, said system comprising:
an advertising display positioned to be viewed by a customer of a business and provide said customer an advertising message, a text number and a request for feedback related to said business from said customer;
a central server for receiving text messages from customers viewing said advertising display, prompting said customers to provide feedback related to said business and storing data received from said customers;
wherein said central server includes software for determining if said customer is entitled to a reward based upon responses received from the customer and, if the customer is entitled to a reward, provides said customer with instructions on obtaining said reward.

15. The system of claim 14 further comprising a web interface that allows customers to access summary data related to feedback received from customers.

16. The system of claim 15 wherein access to portions of said web interface is restricted through passwords to advertisers that sponsor said advertising display.

17. The system of claim 15 wherein said central server further comprises software for selecting advertisements for display to said customers and advertisers through said web interface based upon the content of the advertising display which they are associated with.

18. The system of claim 14 further comprising a, receipt generator for generating a receipt having an identification number that identifies the time, place and goods or services associated with a purchase.

19. The system of claim 14 wherein said reward further comprises a code for receiving a discount.

20. The system of claim 14 further comprising a statistical generator that generates statistics based upon said customer data for review by an advertiser associated with said advertising display.
